(19) United States
(12) Patent Application Publication
(10) Pub. No.: US 2007/0115591 A1
(43) Pub. Date: May 24, 2007

(54) Suspension, head gimbal assembly and disk drive unit with the same

(75) Inventors: MingGao Yao, DongGuan (CN); ZhaoHui Yang, HongKong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/282,751

(22) Filed: Nov. 21, 2005

(51) Int. Cl. G11B 5/48

(52) U.S. Cl. 360/245.3

(57) ABSTRACT

A suspension for a HGA of the invention includes a flexure having a plurality of connection pads to connect with a control system at one end and a plurality of electrical multi-traces at the other end; which comprising: a tongue to hold the slider; a suspending portion to suspend the tongue from the flexure; wherein the suspending portion has a narrower width than that of the tongue. The invention also discloses a HGA with such a suspension and a disk drive unit having such an HGA.

### FIELD OF THE INVENTION

The present invention relates to disk drive units, and particularly relates to a head gimbal assembly (HGA) having a suspension with an optimum stiffness; the invention also relates to a head gimbal assembly (HGA) having a suspension with trace support bridges for supporting multi-traces on the suspension.

### BACKGROUND OF THE INVENTION

Disk drives are information storage devices that use magnetic media to store data. Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using for the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

As a way to improve the positional control of the read/write head, Various dual-stage actuator systems have been developed in the past for the purpose of increasing the speed and fine tuning the position of the read/write head over the desired tracks on high density storage media. Such dual-stage actuator systems typically include a primary voice-coil motor (VCM) actuator and a secondary micro-actuator, such as a PZT micro-actuator. The VCM actuator is controlled by a servo control system that rotates the actuator arm that supports the read/write head to position the read/write head over the desired information track on the storage media. The PZT micro-actuator is used in conjunction with the VCM actuator for the purpose of increasing the positioning speed and fine tuning the exact position of the read/write head over the desired track. Thus, the VCM actuator makes larger adjustments to the position of the read/write head, while the PZT micro-actuator makes smaller adjustments that fine tune the position of the read/write head relative to the storage media. In conjunction, the VCM actuator and the PZT micro-actuator enable information to be efficiently and accurately written to and read from high density storage media.

FIG. 1 a shows a typical disk drive unit with a head displacement control system. FIG. 1a illustrates a portion of a conventional disk drive unit and shows a magnetic disk 101 mounted on a spindle motor 102 for spinning the disk 101. A voice coil motor arm 104 carries a HGA 100 that includes a micro-actuator 105 and a read/write head 103. A voice-coil motor (VCM) is provided for controlling the motion of the motor arm 104 and, in turn, controlling the slider 103 to move from track to track across the surface of the disk, thereby enabling the read/write head to read data from or write data to the disk. In operation, a lift force is generated by the aerodynamic interaction between the slider, incorporating the read/write head, and the spinning magnetic disk. The lift force is opposed by equal and opposite spring forces applied by a suspension of the HGA such that a predetermined flying height above the surface of the spinning disk is maintained over a full radial stroke of the motor arm 104.

FIG. 1b illustrates the HGA 100 of the conventional disk drive device of FIG. 1a incorporating a dual-stage actuator. However, because of the inherent tolerances of the VCM and the head suspension assembly, the slider 103 cannot achieve quick and fine position control which adversely impacts the ability of the read/write head to accurately read data from and write data to the disk. As a result, a PZT micro-actuator 105, as described above, is provided in order to improve the positional control of the slider and the read/write head. More particularly, the PZT micro-actuator 105 corrects the displacement of the slider 103 on a much smaller scale, as compared to the VCM, in order to compensate for the resonance tolerance of the VCM and head suspension assembly. The micro-actuator 105 enables, for example, the use of a smaller recording track pitch, and can increase the “tracks-per-inch” (TPI) value by 50% for the disk drive unit, as well as provide an advantageous reduction in the head seeking and settling time. Thus, the PZT micro-actuator 105 enables the disk drive device to have a significant increase in the surface recording density of the information storage disks used therein.

As shown in FIGS. 1a and 1b, one known type of micro-actuator is a U-shaped micro-actuator 105. This U-shaped micro-actuator 105 has two side arms 107 that hold the slider 103 therebetween and displace the slider by movement of the side arms. The PZT micro-actuator 105 is capable to corrects the displacement of the slider 103 on a much smaller scale since two PZT elements are attached on the two side arm, the voltage from the control system will induce the PZT element deform by which adjust the head position.

Referring more particularly to FIG. 1c, a conventional PZT micro-actuator 105 includes a ceramic U-shaped frame which has two ceramic beams or side arms 107 each having a PZT element thereon. With reference to FIGS. 1b and 1c, the PZT micro-actuator 105 is physically coupled to a flexure 114. Three electrical connection balls 109 (gold ball bonding or solder ball bonding, GBB or SBB) are provided to couple the micro-actuator 105 to the suspension inner traces 910 located at the side of each of the ceramic beams 107. In addition, there are four metal balls 108 (GBB or SBB) for coupling the slider 103 to the traces 110.

FIG. 1d generally shows an exemplary process for assembling the slider 103 with the micro-actuator 105. As shown in FIG. 1d, the slider 103 is partially bonded with the two ceramic beams 107 at two predetermined positions 106 by epoxy 112. This bonding makes the movement of the slider 103 dependent on the movement of the ceramic beams 107 of the micro-actuator 105. A PZT element 116 is attached on each of the ceramic beams 107 of the micro-actuator to enable controlled movement of the slider 103 through excitation of the PZT elements. More particularly, when power is supplied through the suspension traces 910, the PZT elements expand or contract to cause the two ceramic beams 107 of the U-shape micro-actuator frame to deform, thereby making the slider 103 move on the track of the disk in order to fine tune the position of the read/write head. In this manner, controlled displacement of the slider 103 can be achieved for fine positional tuning.

As well known in IT industry, with the quickly increasing of the HDD capability, but the actual HDD sell prices becomes lower and lower, the manufacturer are continue to development the method to cut down the material cost in order to meet the market, a typically example is make the head slider smaller and smaller, etc. from 100% type slider to 50% type slider, the current is 30% slider and everyone are focusing on the 20% slider now, since the slider size reduce, the side for the air bearing surface (ABS) reduce also, but the requirement from the higher HDD capacity require a lower and lower head flying height, this give a big challenge on the design for the head ABS shape and the static parameter for the suspension, etc. the stiffness, per ABS design limitation, the lower and lower stiffness is required for the suspension, especially when a micro-actuator is applied, the suspension design becomes a more and more difficulty, this is why we need have a method and design optimization for the small size slider.

Hence, it is desired to provide a suspension with an optimum stiffness, a HGA, and a disk drive with such a suspension to solve the above-mentioned problems.

### SUMMARY OF THE INVENTION

A main feature of the present invention is to provide a suspension having an optimum stiffness which can make a slider mounted thereon having a good flying stability performance and a good resonance performance.

Another feature of the present invention is to provide a HGA having an optimum stiffness which can make its slider having a good flying stability performance and a good resonance performance.

A further feature of the present invention is to provide a disk drive unit with big servo bandwidth and capacity.

To achieve the above-mentioned features, a suspension for a HGA of the present invention comprises a flexure having a plurality of connection pads to connect with a control system at one end and a plurality of electrical multi-traces at the other end. The flexure comprises a tongue to hold the slider; a suspending portion to suspend the tongue from the flexure; wherein the suspending portion has a narrower width than that of the tongue. In the invention, the flexure further comprises a top support bar connecting with the suspending portion in its middle area, and two side support bars to connect with the top support bar in its two ends. In an embodiment, the top support bar has a width larger than 0.085 mm. The side support bar has a width larger than 0.105 mm. The suspending portion has a width ranged from 0.5 mm to 0.9 mm.

In the invention, the suspension further comprising a load beam having a dimple thereon for supporting the tongue. As an embodiment, the dimple is located in the coupling edge between the suspending portion and the tongue. In another embodiment, the dimple is located in the tongue side in regarding to the coupling edge between the suspending portion and the tongue. The distance between the portion of the dimple and the edge of the tongue coupling with the suspending portion is desired to be bigger so as to prevent the displacement of the slider in Z-direction. The flexure further comprises at least a trace support bridge to support the electrical multi-traces. In an embodiment of the invention, the trace support bridge is made of polymer (PI)material.

A HGA of the present invention comprises a slider; a suspension to load the slider; wherein the suspension comprising: a flexure having a plurality of connection pads to connect with a control system at one end and a plurality of electrical multi-traces at the other end; which comprising: a tongue to hold the slider; a suspending portion to suspend the tongue from the flexure; wherein the suspending portion has a narrower width than that of the tongue.

A disk drive unit of the present invention comprises a HGA; a drive arm to connect with the HGA; a disk; and a spindle motor to spin the disk; wherein the head gimbal assembly comprising a slider and a suspension to load the slider; wherein the suspension comprising: a flexure having a plurality of connection pads to connect with a control system at one end and a plurality of electrical multi-traces at the other end; which comprising: a tongue to hold the slider; a suspending portion to suspend the tongue from the flexure; wherein the suspending portion has a narrower width than that of the tongue.

Compared with the prior art, the suspension comprises a flexure with an improve structure to get an optimum stiffness, such as pitch and roll stiffness, lateral stiffness of the suspension. That is, the flexure with improved structure makes the pitch and roll stiffness of the suspension smaller and the lateral stiffness of the suspension larger so as to ensure the slider with a good flying performance and the suspension itself with a good resonance performance. Accordingly, the good resonance performance improve the HDD servo bandwidths and then disk storage performance of the disk drive devices are improved, In addition, the suspension further comprises at least one trace support bridges for supporting the electrical multi-traces on the suspension, so it will prevent the multi-traces deformation and reduce the trace vibration, thus ensuring a good static and dynamic performance of a disk drive device with such the flexure. Also, the trace support bridges can also improve the lateral stiffness of the flexure accordingly, the resonance performance of the disk drive device with such a suspension is improved, and then disk storage performance of the disk drive devices are also improved

For the purpose of making the invention easier to understand, several particular embodiments thereof will now be described with reference to the appended drawings in which:

### DESCRIPTION OF THE DRAWINGS

FIG. 1a shows a partial view of a conventional disk drive unit;

FIG. 1b is a perspective view of a conventional HGA;

FIG. 1c is an enlarged, partial view of the HGA of FIG. 1b;

FIG. 1d illustrates a general process of inserting a slider into the micro-actuator of the HGA of FIG. 1b;

FIG. 2 is a perspective view of a suspension of a HGA according to a first embodiment of the present invention;

FIG. 3 is an exploded, perspective view of the suspension of FIG. 2;

FIG. 4 is a perspective view of a flexure of the suspension of FIG. 3;

FIG. 5 shows a relationship curve between width c of a suspending portion of the flexure in FIG. 4 and pitch and roll stiffness of the suspension;

FIG. 6 shows a relationship curve between width c of the suspending portion of the flexure in FIG. 4 and lateral stiffness of the suspension;

FIG. 7 shows a relationship curve between width w of a top support bar of the flexure in FIG. 4 and pitch and roll stiffness of the suspension;

FIG. 8 shows a relationship curve between width w of the top support bar of the flexure in FIG. 4 and lateral stiffness of the suspension;

FIG. 9 shows a relationship curve between width y of each side support bar of the flexure in FIG. 4 and pitch and roll stiffness of the suspension;

FIG. 10 shows a relationship curve between width y of the side support bar of the flexure in FIG. 4 and lateral stiffness of the suspension;

FIG. 11 is a partial, perspective view of the flexure in FIG. 4 which shows a positional relationship with a dimple of a load beam of the suspension in FIG. 2;

FIG. 12 shows a relationship curve between width c of the suspending portion of the flexure in FIG. 11 and displacement in Z-direction thereof when a longitudinal distance d between a dimple of the suspension and a suspension tongue has different values;

FIG. 13 shows a relationship curve between resonance gain and frequency of the suspension in FIG. 2 when its lateral stiffness has different values;

FIG. 14 shows a relationship curve between resonance phase and frequency of the suspension in FIG. 2 when its lateral stiffness has different values;

FIG. 15 is a partial, perspective view of a flexure with two trace support bridges on its each side according to another embodiment of the invention;

FIG. 16 is a partial, perspective view of a flexure with one trace support bridge on its each side according to a further embodiment of the invention;

FIG. 17 is a partial, perspective view of a flexure having a weight-reduced suspension tongue according to another further embodiment of the invention;

FIG. 18 is an exploded, perspective view of a HGA having the flexure in FIG. 2 according to an embodiment of the invention;

FIG. 19 is perspective view of a disk drive unit having the HGA in FIG. 18 according to an embodiment of the invention.

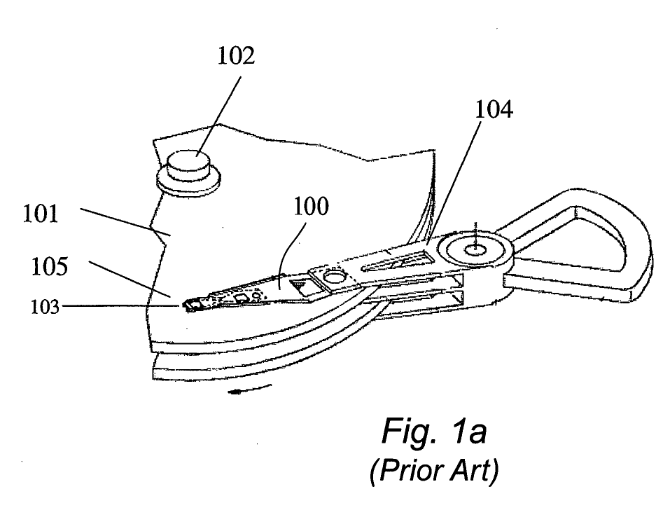

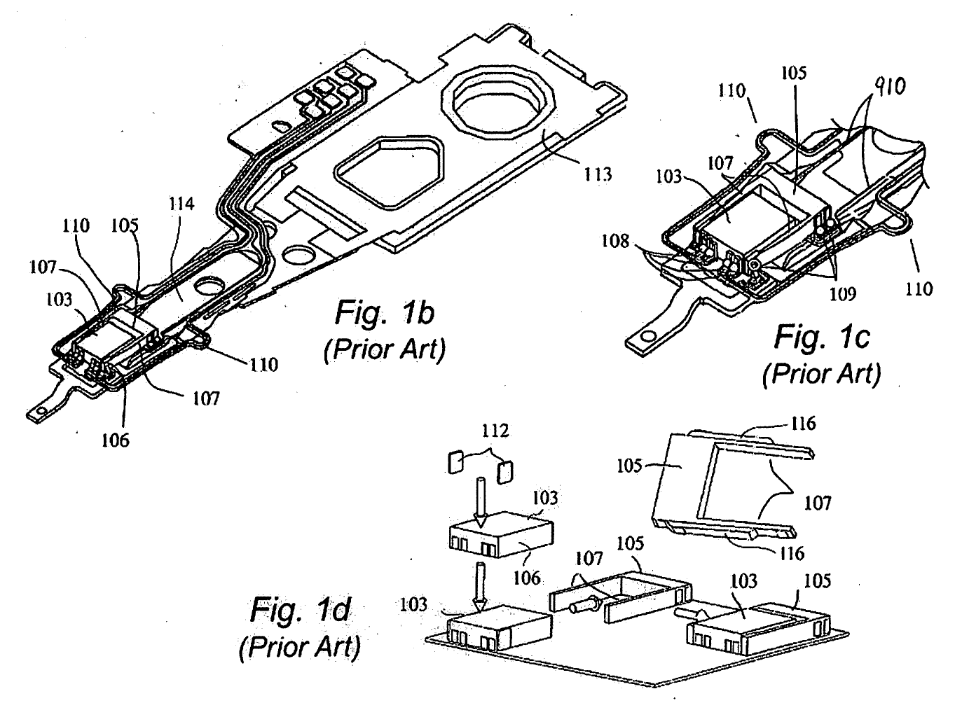

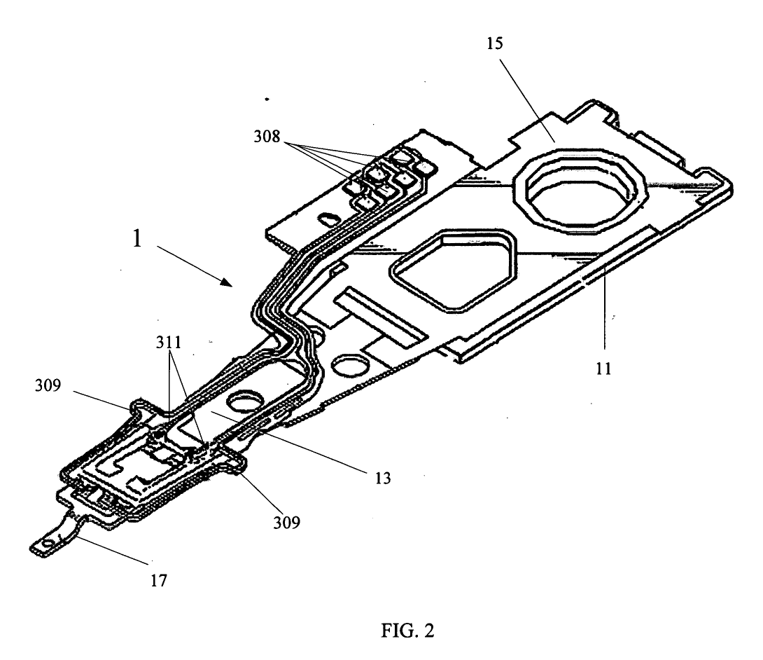

### DETAILED DESCRIPTION OF THE INVENTION

Various preferred embodiments of the instant invention will now be described with reference to the figures, wherein like reference numerals designate similar parts throughout the various views. As indicated above, the instant invention is designed to a suspension having an improved flexure so as to attain an optimum stiffness, especially pitch stiffness, roll stiffness and lateral stiffness so that the head have a good dynamic and static performance with a stable flying height when a small size slider mounted thereon is flying on a rotating disk. In addition, with the stiffness of the suspension is improved, the position of the suspension support from the dimple of the load beam is also optimized, the tongue deformation in correspondence with the displacement in z direction when a loading force is added when head flying on the disk is also reduced, this will maintenance the head flying and micro-actuator work more stable, prevent the unnecessary noise in servo mechanical when the flexure and head touch due to the large deformation of the flexure. So, the suspension of the invention also aims to optimize the structure of the suspension for attaining a good performance when mount a small size slider.

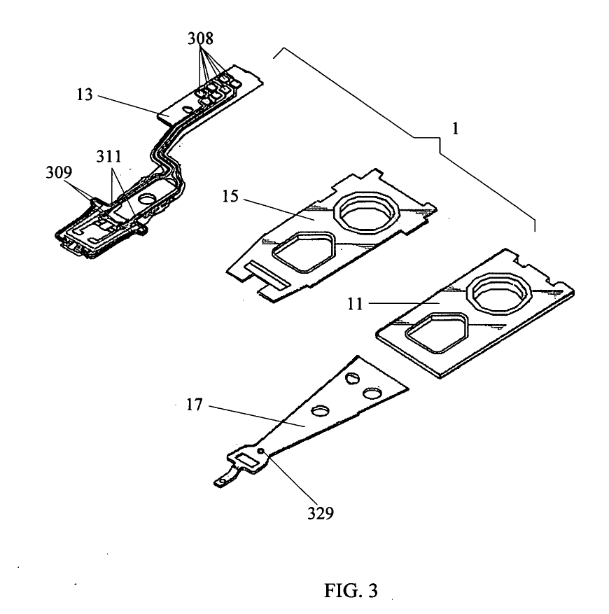

Several example embodiments of the suspension of the invention will now be described. Referring to FIGS. 2 and 3, according to an embodiment of the present invention, a suspension 1 comprises a load beam 17, a flexure 13, a hinge 15 and a base plate 11. The load beam 17 has a dimple 329 formed thereon. On the flexure 13 a plurality of connection pads 308 are provided to connect with a control system (not shown) at one end and a plurality of electrical multi-traces 309, 311 is provided in the other end.

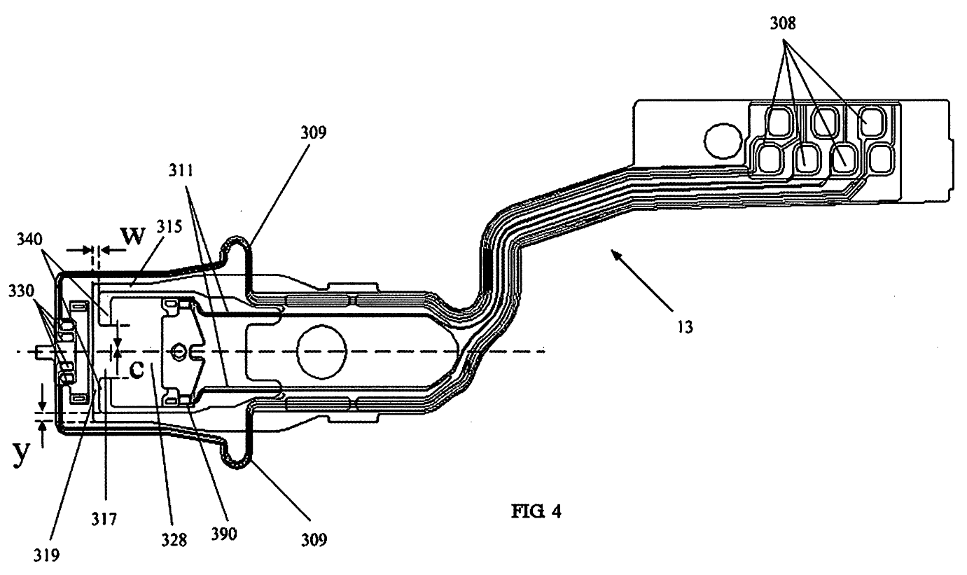

Referring to FIG. 4, the flexure 13 also comprises a suspension tongue 328 which are used for holding a slider (not shown), a suspending portion 317 to suspend the suspension tongue 328 from the flexure 13. In the invention, the suspension tongue 328 comprises a plurality of bonding pads 330 to connect with the electrical multi-traces 309, and a plurality of bonding pads 390 to connect with the electrical multi-traces 311. The suspending portion 317 has a narrower width c than that of the suspension tongue 328. Here, the suspension tongue 328 is suspended from the flexure 13 through the suspending portion 317 so as to attain a spring structure. Since the suspending portion has a narrow width c, this make the suspension tongue have a smaller stiffness in both pitch and roll direction, when mount a slider to the suspension tongue, this smaller pitch and roll stiffness will guarantee the head flying stable.

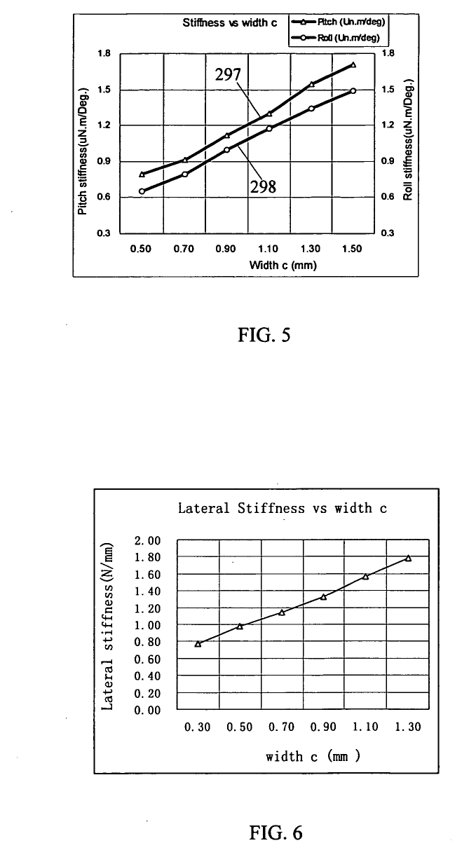

Referring to FIG. 5, it shows a relationship curve between width c of the suspending portion 317 of the flexure 13 and pitch and roll stiffness of the suspension 1 having the flexure 13. Here, curve 297 represents a relationship curve of width c versus pitch stiffness, curve 298 represents a relationship curve of width c versus roll stiffness. From the view, it can be seen that both the pitch stiffness and the roll stiffness of the suspension 1 having the flexure 13 will reduce with the decrease of the width c of the suspending portion 317. In the embodiment, the suspending portion 317 is shaped as a rectangular portion. Obviously, the suspending portion 317 also can be any other suitable shape for reduce the stiffness of the suspension 1. Referring to FIG. 6, it shows a relationship curve between width c of the suspending portion 317 in FIG. 4 and lateral stiffness of the suspension 1 having the flexure 13. From the view, it can be seen that the lateral stiffness of the suspension 1 having the flexure 13 will reduce with the decrease of the width c of the suspending portion 317.

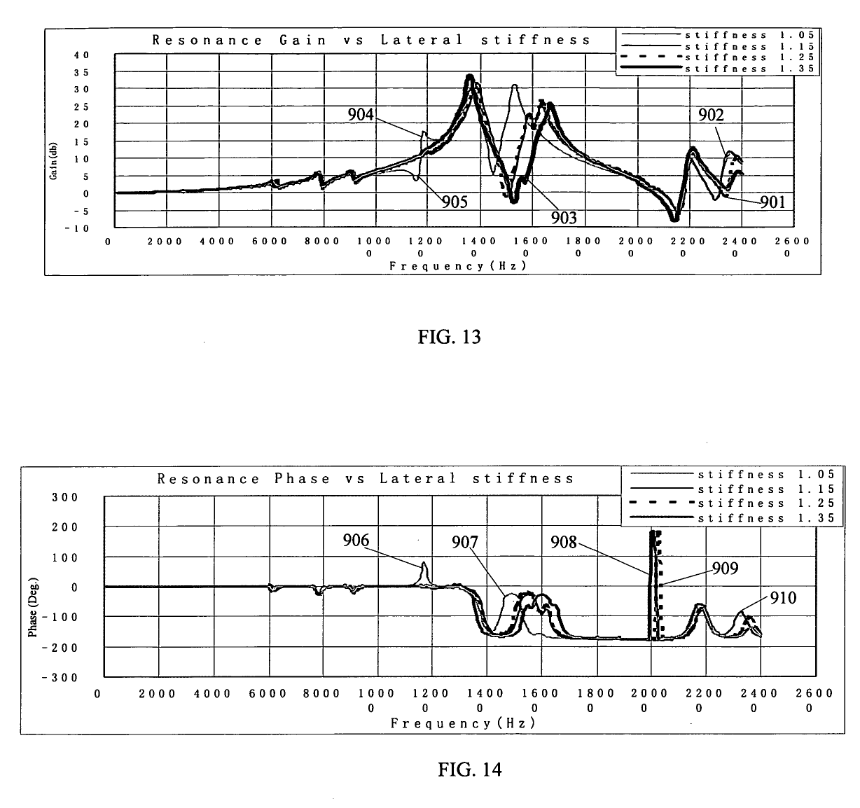

Generally, a suspension with a small size slider, i.e. the slider size of 30% or smaller than 30%, mounted thereon may satisfy the follow conditions to ensure the slider with a good flying stability performance and the suspension itself with a good resonance performance: both the pitch and roll stiffness of the suspension 1 having the flexure 13 should be smaller than 1.00 μN.m/degree; and the lateral stiffness of the suspension 1 having the flexure 13 is larger than 1.00N/mm. The smaller Pitch/Roll stiffness is better for the head flying stability and the large lateral stiffness is better for the resonance of the head gimbal assembly (HGA), as refer FIG. 13 and FIG. 14, it shows a relationship between the HGA resonance and the lateral stiffness of the flexure of the suspension, in FIG. 13, the curves 905, 902, 901, 903 are the related resonance gain curves when the values of lateral stiffness of the suspension 1 are 1.05, 1.15, 1.25, and 1.35 N/mm, respectively. In FIG. 14, curves 907, 910, 909, 908 are respectively resonance phase when the lateral stiffness of the suspension are 1.05, 1.15, 1.25, and 1.35 N/mm. As can be seen from these views, when the lateral stiffness has a value near to 1.00 N/mm, such as 1.05(see curves 905 and 907), a peak 904/906 will appear in the resonance at a low frequency period, this means that the resonance performance becomes bad compare with the resonance of the high lateral stiffness parts, this will affect the dynamic performance of the HGA and affect the servo in the HDD, According to the fact and referring to FIGS. 5 and 6, it can be seen that the width c of the suspending portion 317 is preferably ranged from 0.5 mm-0.9 mm. Understandably, the width c of the suspending portion 317 can be adjusted by actual requirement and the slider size.

Referring to FIG. 4, the flexure 13 may further comprise a top support bar 319 connecting with the suspending portion 317 in its middle area, and two side support bars 315 to connect with the top support bar 319 in its two ends. The top support bar 319, the two side support bars 315, the suspending portion 317 and the flexure 13 define two notches 340 thereon. In an embodiment, the two notches 340 are arranged symmetrically at two sides of the suspending portion 317. In the invention, the distance between the top support bar 319 and the suspension tongue 328, i.e. the length of the suspending portion 317 can be altered according to actual requirement.

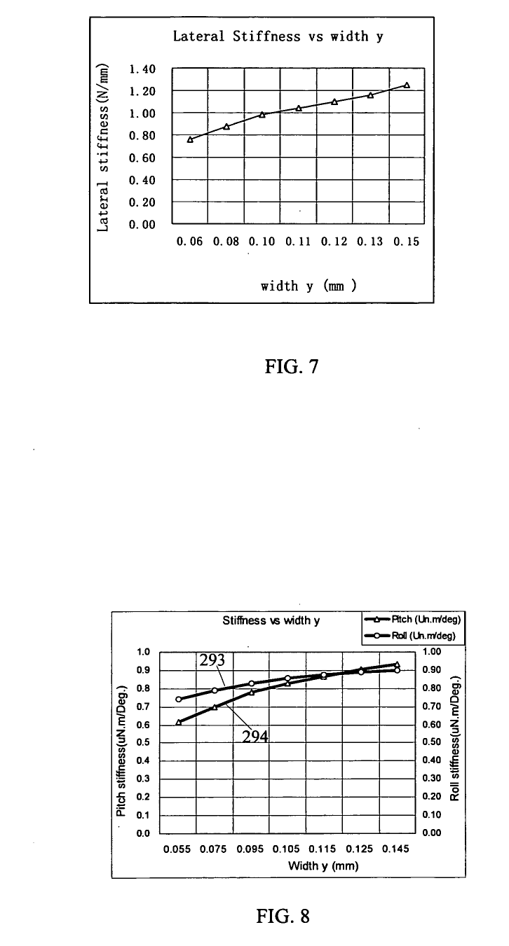

In the invention, the top support bar 319 has a width w which also influences the stiffness, especially pitch stiffness, roll stiffness and lateral stiffness of the suspension 1 having the flexure 13. Referring to FIG. 7, it shows a relationship curve between width w of the top support bar 319 and pitch and roll stiffness of the suspension 1 having the flexure 13. Here, curve 292 represents a relationship curve of width w versus pitch stiffness; curve 291 represents a relationship curve of width w versus roll stiffness. From the view, it can be seen that both the pitch stiffness and the roll stiffness of the suspension 1 having the flexure 13 will reduce with the decrease of the width w of the top support bar 319. Referring to FIG. 8, it shows a relationship curve between the width w of the top support bar 319 and lateral stiffness of the suspension 1 having the flexure 13. From the view, it can be seen that the lateral stiffness of the suspension 1 having the flexure 13 will reduce with the decrease of the width w of the top support bar 319. Similarly, to ensure the slider with a good flying performance and the suspension itself with a good resonance performance, the pitch and roll stiffness of the suspension 1 having the flexure 13 should be smaller than 1.00 μN.m/degree; and the lateral stiffness of the suspension 1 having the flexure 13 is larger than 1.00N/mm. According to the fact and referring to FIGS. 7 and 8, it can be seen that the width w of the top support bar 319 is preferably larger than 0.085 mm. Understandably, the width w of the top support bar 319 can be adjusted by actual requirement and the slider size.

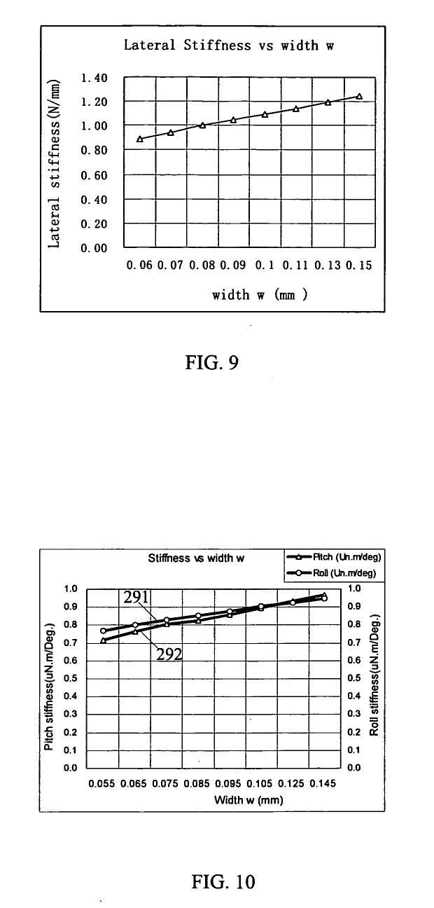

In the invention, each of the side support bars 315 has a width y which also influences the stiffness, especially pitch stiffness, roll stiffness and lateral stiffness of the suspension 1 having the flexure 13. Referring to FIG. 9, it shows a relationship curve between the width y of the side support bar 315 and pitch and roll stiffness of the suspension 1 having the flexure 13. Here, curve 294 represents a relationship curve of width y versus pitch stiffness; curve 293 represents a relationship curve of width y versus roll stiffness. From the view, it can be seen that both the pitch stiffness and the roll stiffness of the suspension 1 having the flexure 13 will reduce with the decrease of the width y of the side support bar 315. Referring to FIG. 10, it shows a relationship curve between the width y of the side support bar 315 and lateral stiffness of the suspension 1 having the flexure 13. From the view, it can be seen that the lateral stiffness of the suspension 1 having the flexure 13 will reduce with the decrease of the width y of the side support bar 315. Similarly, to ensure the slider with a good flying performance and the suspension itself with a good resonance performance, both the pitch and roll stiffness of the suspension 1 having the flexure 13 should be smaller than 1.00 μN.m/degree; and the lateral stiffness of the flexure 13 is larger than 1.00 N/mm. According to the fact and referring to FIGS. 9 and 10, it can be seen that the width y of the side support bar 315 is preferably larger than 0.10 mm. Understandably, the width y of the side support bar 315 can be adjusted by actual requirement and the slider size.

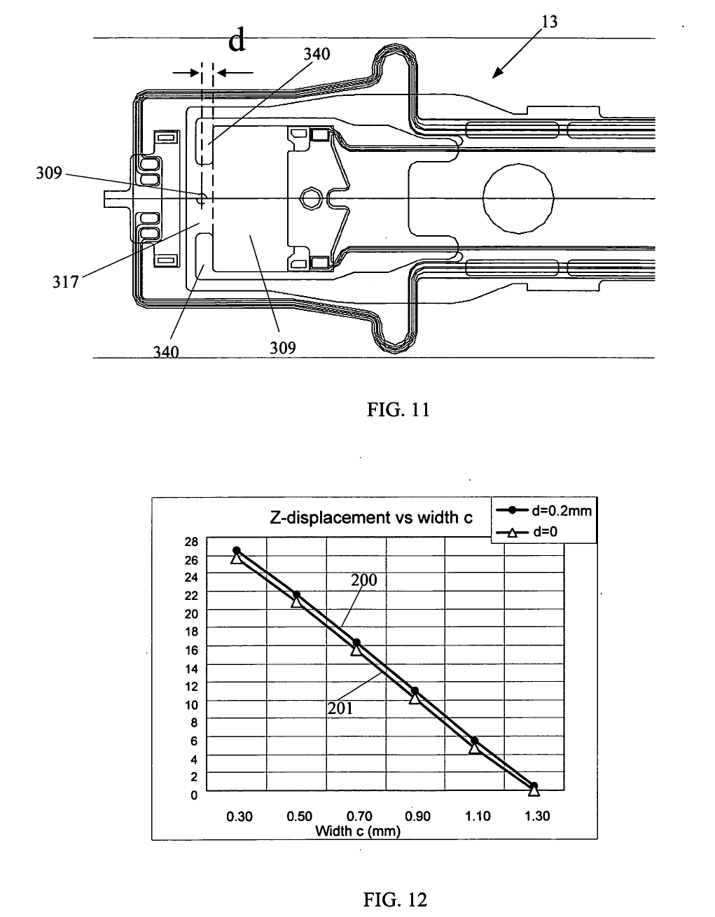

In the invention, referring to FIGS. 2-4, when the flexure 13 is assembled with the load beam 17, the hinge 15 and the base plate 11 to form the suspension 1, the dimple 329 of the load beam 17 will support the suspending portion 317 and keep the loading force always being applied to the center area of a slider. Referring to FIG. 11, because there are two notches 340 are symmetrically formed at two sides of the suspending portion 317, so a spring structure is thus formed on the suspension 1 with the dimple 329 as a support pivot, according to lever principle, a distance d from the dimple 319 to a connection edge of the suspension tongue 328 with the suspending portion 317 will affect the Z-direction displacement of the slider mounted on the flexure 13 due to the suspending parts and the tongue deformation. Referring to FIG. 12, it shows a relationship curve between width c of the flexure 13 and displacement in Z-direction thereof when the distance d has different values. Here, curve 200 represents a relationship curve when the distance d has a value of 0.2 mm; curve 201 represents a relationship curve when the distance d has a value of 0 mm. As can be seen from the view, when the width c of the suspending portion 317 is same, the displacement of the slider in Z-direction becomes small with the decrease of the distance d. Therefore, the distance d is preferably near to zero so as to prevent the displacement of the slider in Z-direction when the other parameters of the suspension 1 are the same.

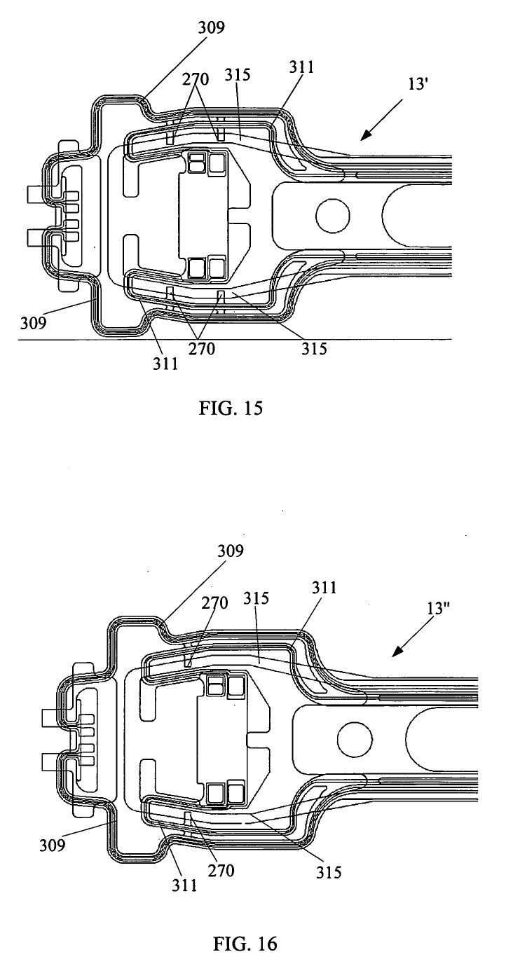

Referring to FIG. 15, according to another embodiment of the invention, a flexure 13′ has a similar structure to the flexure 13 in FIG. 2, but may further comprise two trace support bridges 270 on its each side to support the electrical multi-traces 309, 311. In the embodiment, the trace support bridges 270 is bar-shaped which extends from the side support bar 315 and has a enough length to support the electrical multi-traces 309, 311. Preferably, the bridges 270 can be made of polymer (PI) material so as to attain a good stiffness and rigidity. Understandably, the bridges 270 can be made of any other suitable material for supporting the electrical multi-traces 309, 311. Because the trace support bridges 270 supports the electrical multi-traces 309, 311, so it will prevent the multi-traces 309, 311 from deformation during the manufacture process and reduce the trace vibration during head flying on the disk, thus ensuring a good static and dynamic performance of the HGA for a disk drive device with such the flexure 13′. Also, the trace support bridges 270 can also improve the lateral stiffness of the flexure 13, this is helps for the head static and dynamic performance.

Referring to FIG. 16, according to a further embodiment of the invention, a flexure 13″ has a similar structure to the flexure 13′ in FIG. 15, but may only comprise one trace support bridge 200 on its each side to support the electrical multi-traces 309, 311. The trace support bridge 200 also extends from the side support bar 315. Understandably, the amount of the trace support bridges 270 can be altered according to actual requirement of the flexure and the suspension; in addition, the shape of the trace support bridges 270 can be any other suitable shape for supporting the electrical multi-traces 309, 311.

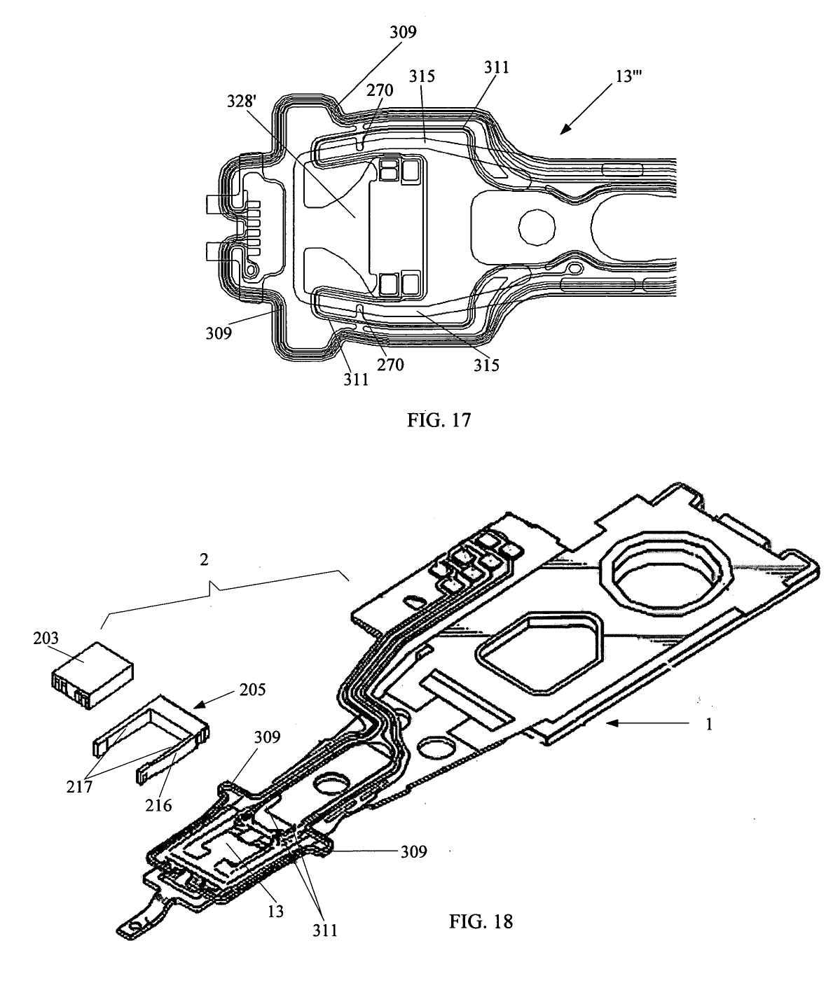

Referring to FIG. 17, according to an embodiment of the invention, a flexure 13′″ has a similar structure to the flexure 13 in FIG. 2, but it has a different suspension tongue 328′ with a weight-reduced structure comparing with the suspension tongue 328 of FIG. 4. In an embodiment, as shown in FIG. 17, the suspension tongue 328′ is shaped as a trapezoid. However, the suspension tongue 328′ is not limited to such a shape, any suitable shape can be used to reduce the weight thereof and attain an optimum stiffness for the flexure 13′″. In the embodiment, the suspension tongue 328′ has a weight-reduced structure so as to reduce the whole weight of the flexure 13′″ and the suspension, thus a shock performance of a disk drive device with such a flexure is improved.

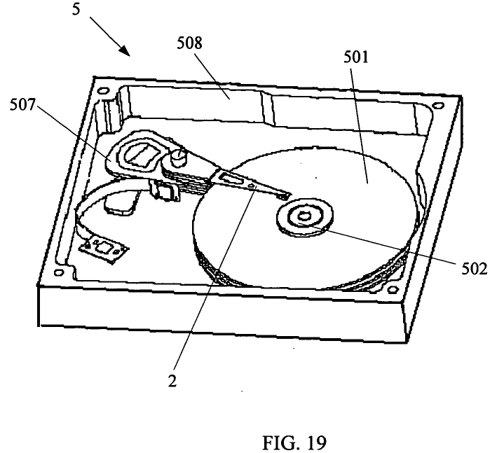

Referring to FIG. 18, according to an embodiment of the invention, a HGA 2 comprises a slider 203; a U-shaped micro-actuator 205 having two side arms 217 that hold the slider 203 therebetween and displace the slider 203 by movement of the side arms 217; a suspension 1 to load the slider 203 and the micro-actuator 205. In the embodiment, the micro-actuator 105 includes a ceramic U-shaped frame which has two side arms 217 each having a PZT element 216 thereon. The PZT micro-actuator 105 is physically coupled to a flexure 13 by adhesive such as epoxy. A plurality of electrical connection balls (gold ball bonding or solder ball bonding, GBB or SBB, not shown) are provided to couple the micro-actuator 105 to the suspension traces 311 located at the side of each of the side beams 217. In addition, there are a plurality of electrical connection metal balls (GBB or SBB, not shown) for coupling the slider 203 to the traces 309. In the invention, the micro-actuator 205 is not limited to a U-shaped micro-actuator, the other suitable micro-actuators, such as thin film type micro-actuators, metal support type (instead of the ceramic material of the U-shape micro-actuator 205) micro-actuators can be applied in the invention. Understandably, a HGA may have not a micro-actuator, and the slider 203 is displaced only by a VCM of a disk drive device.

According to an embodiment of the present invention, referring to FIG. 19, a disk drive unit 5 can be attained by assembling a housing 508, a disk 501, a spindle motor 502, a VCM 507 with the HGA 2 of the present invention. Because the structure and/or assembly process of disk drive unit of the present invention are well known to persons ordinarily skilled in the art, a detailed description of such structure and assembly is omitted herefrom.

While the preferred forms and embodiments of the invention have been illustrated and described herein, various changes and/or modifications can be made within the scope of the instant invention. Thus, the embodiments described herein are meant to be exemplary only and are not intended to limit the invention to any of the specific features thereof, except to the extent that any of specific features are expressly recited in the appended claims.

What is claimed is:

1. A suspension for a head gimbal assembly, which comprising:
a flexure having a plurality of connection pads to connect with a control system at one end and a plurality of electrical multi-traces at the other end; which comprising:
a tongue to hold the slider;
a suspending portion to suspend the tongue from the flexure; wherein the suspending portion has a narrower width than that of the tongue.

2. The suspension as claimed in claimed 1, wherein the flexure further comprises a top support bar connecting with the suspending portion in its middle area, and two side support bars to connect with the top support bar in its two ends.

3. The suspension as claimed in claimed 2, wherein the top support bar has a width larger than 0.085 mm.

4. The suspension as claimed in claimed 2, wherein the side support bar has a width larger than 0.10 mm.

5. The suspension as claimed in claimed 1, wherein the suspending portion has a width ranged from 0.5 mm to 0.9 mm.

6. The suspension as claimed in claimed 1, wherein the suspension further comprising a load beam having a dimple thereon for supporting the tongue, the dimple is positioned to support the suspending portion.

7. The suspension as claimed in claimed 6, wherein the dimple is located in the coupling edge between the suspending portion and the tongue.

8. The suspension as claimed in claimed 6, wherein the dimple is located in the tongue side in regarding to the coupling edge between the suspending portion and the tongue.

9. The suspension as claimed in claimed 2, wherein the flexure further comprises at least a trace support bridge to support the electrical multi-traces.

10. The suspension as claimed in claimed 9, wherein the trace support bridge is made of PI material.

11. A head gimbal assembly comprising:
a slider;
a suspension to load the slider; wherein the suspension comprising:
a flexure having a plurality of connection pads to connect with a control system at one end and a plurality of electrical multi-traces at the other end; which comprising:
a tongue to hold the slider;
a suspending portion to suspend the tongue from the flexure; wherein the suspending portion has a narrower width than that of the tongue.

12. The head gimbal assembly as claimed in claimed 11, wherein the suspension further comprising a load beam having a dimple thereon for supporting the tongue, the dimple is positioned to support the suspending portion.

13. The head gimbal assembly as claimed in claimed 11, wherein the flexure further comprises a top support bar connecting with the suspending portion in its middle area, and two side support bars to connect with the top support bar in its two ends.

14. The head gimbal assembly as claimed in claimed 13, wherein the top support bar has a width larger than 0.085 mm.

15. The head gimbal assembly as claimed in claimed 13, wherein the side support bar has a width larger than 0.10 mm.

16. The head gimbal assembly as claimed in claimed 12, wherein the dimple is located in the coupling edge between the suspending portion and the tongue.

17. The head gimbal assembly as claimed in claimed 12, wherein the dimple is located in the tongue side in regarding to the coupling edge between the suspending portion and the tongue.

18. The head gimbal assembly as claimed in claimed 12, wherein the flexure comprises at least a trace support bridge to support the electrical multi-traces.

19. The head gimbal assembly as claimed in claimed 18, wherein the bridge is made of PI material.

20. The head gimbal assembly as claimed in claimed 12, wherein the head gimbal assembly further comprises a micro-actuator to hold and displace the slider.

21. A disk drive unit comprising:
a head gimbal assembly;
a drive arm to connect with the head gimbal assembly;
a disk; and
a spindle motor to spin the disk; wherein the head gimbal assembly comprising a slider and a suspension to load the slider; wherein the suspension comprising:
a flexure having a plurality of connection pads to connect with a control system at one end and a plurality of electrical multi-traces at the other end; which comprising:
a tongue to hold the slider;
a suspending portion to suspend the tongue from the flexure; wherein the suspending portion has a narrower width than that of the tongue.
